(19) United States
(12) Patent Application Publication
(10) Pub. No.: US 2006/0201396 A1
(43) Pub. Date: Sep. 14, 2006

(54) Dry tinted cement mixture

(76) Inventor: Geoffrey Ellery Smith, Carmel Valley, CA (US)

Correspondence Address: Pacific Patents & Technology, PO Box 736, Rehoboth, MA, 02769, US

(21) Appl. No.: 11/374,516

(22) Filed: Mar. 13, 2006

Related U.S. Application Data
(60) Provisional application No. 60/661,129, filed on Mar. 12, 2005.
(60) Provisional application No. 60/723,208, filed on Oct. 3, 2005.

(51) Int. Cl. C04B 16/00; C04B 14/00

(52) U.S. Cl. 106/712

(57) ABSTRACT

The invention disclosure herein describes a method and formulations to produce dry tinted cement mixture, with product colors to match desired landscapes. The methods described produce a solid durable concrete-like structure, with a water permeable structure and with color to match a surrounding environment. Dry tinted cement mixture comprises a mixture of colorant and cement, which is blended together with crushed rock aggregate. The dry mixture is then slightly moistened while blending, such as with light mistings of water in a typical cement mixer. Once the mixture is blended and moistened, and before the cement sets and hardens, the slightly moistened mixture is poured into the desired location, spread, and compressed to grade, such as with rollers or tamping devices. As the material sets, light mistings of water can be applied to facilitate good hardening, and the top surface of the material can be smoothed or textured.

### PRIORITY CLAIMS AND RELATED APPLICATIONS

This Utility Patent Application for “Dry Tinted Cement Mixture” filed on Mar. 12, 2006 is a Continuation-in-Part to U.S. Provisional Patent Applications Nos. 60/661,129 filed Mar. 12, 2005, and 60/723,208 filed Oct. 3, 2005 and claims the benefit of the priority dates of those two U.S. Provisional Patent Applications. The aforementioned U.S. Provisional Patents Applications Nos. 60/661,129 and 60/723,208 are hereby incorporated by reference in their entirety and for all purposes into this Patent Application.

### BACKGROUND

Conventional concrete is often used for walk ways and roads, and produces a hard and durable surface, yet it is however expensive and very labor intensive. Conventional concrete also is not water permeable, to allow rain water to percolate through to the ground soil. Conventional methods of color tinting cementaceous mixtures are typically done when the mixture is fully wetted.

Conventional concrete mix is usually prepared as a mixture of cement, #2 sand, and rock nuggets which are typically in the size range of ⅜ inch to ¾ inch in size. This is tumble blended and saturated with enough water to make a fluid slurry. This wet concrete mixture is then poured into a reinforced form, typically including rebar or wire mesh framework, where it is finished, carefully surfaced, and allowed to harden. When wet cement is poured into a form, such as a road or patio, the typical desired result in a good pour is to work the wet material with tools to remove all air pockets and hollow spots, to produce a solidified concrete batch which has no significant air spaces. Thus the resultant concrete material is non-permeable to water, and rain water left on the surface will not percolate through. Furthermore, the finishing of a concrete pour is often a painstaking process, where the material is typically worked very carefully with a series of long handled tools such as shovels, screeds, bull-floats and other such tools which are know and used in the art. Typical concrete has a very uniform grey color, varying only slightly in hue depending upon the color and type of rock and sand used. Concrete colorants have been known and used to alter the finished color of conventional concrete, however colored wet cement mixtures do not produce a finished product which is water permeable. The term, water permeable material, as used in this disclosure, shall refer to a solid material that can be permeated or penetrated by water, and in particular to a material which allows at least some water and moisture to permeate interconnecting pore spaces of the material and drain through to the underlying layers below the material, and of having in particular, more porosity and water-permeability than conventional concrete. Conventional concrete has been used with colorants, as have plasters and other cement based blends.

Other road surfacing products are also known in the industry, which use rock aggregates, comprising various sized rock and sand components. Some methods blend aggregates with tar or other organic binders, such as in making asphalt. Water permeable asphalt type surfacing materials have also been used, some of which use specialty organic binder agents, some use epoxies, and some methods rely on specially screened specific sizes of ingredients for water permeability, and some even including granulated glass or ceramic instead of or along with rock and sand. Some of these such prior methods have used colorants. None of these prior methods or formulations are as easy or low cost as the inventive dry tinted cement mixture disclosed herein.

Pathways made of simple crushed rock, even if wetted, packed and tamped, are unlike the invention disclosed herein, since they do not hold their shape and surface texture when subjected to heavy foot traffic, bicycle traffic, vehicle traffic and the like, or severe weather, all of which tend to distort and disrupt the integrity of a previously flattened and packed pathway surface.

### BRIEF SUMMARY OF THE INVENTION

The invention disclosure herein describes a method and formulations to produce dry tinted cement mixture, with product colors to match desired landscapes. The methods described are used to produce a solid durable concrete-like structure, yet with a water permeable structure and with a color to match a surrounding environment. Dry tinted cement mixture comprises a mixture of colorant and cement, which is blended together with crushed rock aggregate. The dry mixture is then slightly moistened while blending, such as with one or more light mistings of water in a typical cement mixer.

Once the mixture is blended and moistened, and before the cement sets and hardens, the slightly moistened mixture is poured into the desired location, spread to slightly higher than desired finished grade, and compressed to grade, such as with rollers or tamping devices. As the material sets one or more additional light mistings of water can be applied to facilitate good hardening, and the top surface of the poured and tamped material can be smoothed or textured.

The inventive method and formulations can allow the appearance of the finished tinted cement mixture to resemble the color and texture of a dirt road, such as a walkway of crushed granite. Although a finished dry tinted cement mixture resembles a crushed granite roadway, it is actually a hard durable material, where the crushed rock elements are chemically bonded together in the inventive method using a lightly moistened, tinted cement mixture, blended with crushed rock, and tamped down into place.

Unlike conventional concrete, the inventive dry tinted cement mixture can be made to allow water and moisture to percolate. The finished product is very useful for surfacing bike paths, pedestrian walkways, patios, off street parking, patios, and such, where attractive appearance and or water permeability may be desired. Many different finished colored embodiments can be achieved by adjusting the amount and types of colorant. Varied levels of porosity and moisture permeability can be attained by adjusting the sizes and size ratios of aggregates used in a particular mixture embodiment. Thus the inventive dry tinted cement mixture method and formulations disclosed herein produce a novel solid structure material which allows water and moisture to percolate.

Although the actual finished product strength of the dry tinted cement mixture may not be as high as for conventional concrete, the product is very useful for surfacing hiking trails, bike paths, pedestrian walkways, off street parking areas, patios, and other such durable landscaping usages where attractive appearance and or water permeability may be desired.

The new dry tinted cement mixture method and formulations give the ability to match a color to blend in with various landscaping. Thus the dry tinted cement mixture is strong and durable, and allows for lower cost and easier installation than conventional cement, yet allows water permeability, and coloration to blend in with landscaping.

The inventive method and formulations can allow the appearance of the finished tinted cement mixture to resemble the color and texture of a dirt road, such as a walkway of crushed granite. In some other particular embodiments, a dry tinted cement mixture can be made with a formulation to resemble the color of new red building bricks, or formulations for old red bricks or other rock-like materials including but not limited to, sand color, adobe color, and earthy brown shades of color. Thus a dry tinted cement mixture can be colored and laid to resemble a new, or old brick walkway, a crushed granite walkway, an adobe or earth colored patio, a sandy surface, or many other obvious variations as can be derived by those skilled in the arts. Additional color splotches or hues can be also added to the surface, such as splotches of white tinted mortar or paint to resemble used brick. In other usages, streaks of darker or lighter colors can be added to even further resemble an earth-colored garden pathway, or other particular landscape design.

Another feature of the dry tinted cement mixture, is that it may be surface textured prior to hardening, such as by hand troweling to create a smooth finish.

### BRIEF DESCRIPTION OF THE FIGURES

FIG. 1 Picture of one type of power mixer useable for small and medium sized areas.

FIG. 2 Picture of a cement mixing truck, usable for blending dry ingredients of a mixture prior to moistening, and also for mixing steps comprising slightly moistened mixtures.

FIG. 3 Picture of a man using a shovel to excavate an area to be surfaced with dry tinted cement mixture.

FIG. 4 Picture of a man using a level to set the grade.

FIG. 5 Picture of a man preparing the roadbed and borders.

FIG. 6 Picture of a man using a wheelbarrow to pour slightly moistened mixture into a prepared area to be surfaced.

FIG. 7 Picture of a man using a rake to spread dry tinted cement mixture into a prepared area to be surfaced.

FIG. 8 Picture of a man using a lawn roller to compress moistened mixture into an area to be surfaced.

FIG. 9 Picture of a power tamping machine called a Vibra-plate, useable for compression of mixture in small and medium sized areas.

FIG. 10 Picture of large scale grading earth moving equipment suitable for preparing large areas to be surfaced, such as parking lots and large roadways.

FIG. 11 Picture of a cement mixing plant loading a cement mixing truck. Such Equipment is suitable for large scale area surfacing projects, for blending formula ingredients of dry tinted cement mixture.

FIG. 12 Picture of a Mobile cement mixer truck suitable for blending and placement of mixtures for moderate sized areas to be surfaced. With this type of equipment, mixture formulation ingredients can be loaded into separate compartments in the truck mounted units. The ingredients are metered and blended in a mixing component, and discharged by an auger from the mixer onto the area to be surfaced. Small and moderate sized mixture batches can be made fresh as needed with this type of equipment.

### DETAILED DESCRIPTION OF THE INVENTION

Dry tinted cement mixture is made comprising cement and color tint, mixed together while dry. The material can be thoroughly blended and packaged such as in standard types of cement sacks, either with or without rock aggregate added to the dry mixture at the time of packaging or delivery. If the dry mixture contains rock aggregate blended at a cement plant prior to packaging, then the cement plant operators can achieve good quality control for producing the right blend of dry mixture for producing a desired end product. In the case of packaging a dry tinted cement mixture which is packaged and distributed without including the crushed rock aggregate when packaging, then an end user will need to add the rock aggregate, and the resultant color may vary depending upon the type and color of rock aggregate which will be added. By carefully adjusting the formulas using different types and amount of cement colorant tints, the inventive product can be made by those skilled in the art to match particular desired landscapes. For example, in one preferred embodiment, which will be used for example herein to demonstrate how to make and use the invention, the product can be made as a hard durable walkway, which is made to look like a walkway path of decomposed granite.

In one preferred embodiment for producing a pourous, colored, solid cementaceous material, dry tinted cement mixture is made comprising; cement and colorant, which is mixed together with rock aggregate, and blended together with a nominal amount of water, such as one or more light mistings of water. A blended and slightly wetted mixture is then poured into place, spread, tamped, and allowed to set, to produce a hard durable and porous rock-like solid material which can be applied in bulk area applications.

For producing this pourous material, it is important to use only a very small amount of water, sufficient to only slightly moisten the dry mixture. Adding too much water will cause the mixture to become sticky and difficult to work into place. One way to gauge sufficient amount of water misting is to add only enough water until the blended mixture begins to bead up into marble-like balls, but less than the amount which makes the mixture wet and sticky, and significantly less water than used in conventional concrete methods where the concrete is wetted to form a pourable slurry.

Decomposed granite, which is well known in the industry as D.G., is a good selection of rock aggregate type for making a walkway from the dry tinted cement mixture. This crushed rock aggregate known as D.G. has a natural golden color, and is very commonly used for walkways and packed earth roads, where a natural looking pathway is preferred over one of concrete or asphalt, and especially where drainage and water percolation are also useful. D.G. is typically crushed granite aggregate, composed of a mixture of aggregate sizes, including a range of fine and course sands, spanning the spectrum of randomly sized particles, up to about one quarter inch sized chunks or larger, depending upon the texture and other properties desired for a particular usage.

With the invention described herein, a pathway comprising a dry tinted cement mixture can be made and used, which is stronger and more durable than simple rock pathways. A pathway made with a dry tinted cement mixture has more porosity and water permeability than pathways made of conventional concrete. By adding the cement to crushed rock with a nominal amount of water, the resultant walkway becomes significantly stronger and more durable than the simple packed rock methods, since the cement chemically binds with the fine and coarse pieces of aggregate to form a rigid structure. By adding the cement colorant in the inventive formulation, the end resultant pathway product can be made to resemble the color of natural crushed rock. Without the colorant, the resultant product is typically an institutional type of gray which is unappealing in many natural landscape settings.

By adding cement colorant to cement as described herein, various options of colored resultant products can be made. In the present example of making a pathway using a dry tinted cement mixture, a color of golden yellow, resembling natural decomposed granite is desired.

If not enough colorant is added, but the cement and aggregate are blended, moistened, and applied, then the resultant product comes out an ugly gray. By adding an appropriate amount of colorant to the formulated mixture, a resultant pathway color can be made to blend in with a desired landscaping effect.

An example of one embodiment of a method and formula for making and using a particular color of dry tinted cement mixture is as follows; In the present example of an embodiment of making a pathway from a dry tinted cement mixture where the resultant pathway resembles a pathway of D.G., a golden color is desired. A formulation which is useful in making the dry tinted cement mixture to this color, shall be named as an example embodiment herein as Formula A.

A dry tinted cement mixture using Formula A can be made comprising a mixture of cement, such as portland cement known in the arts of construction and roadways, and yellow cement colorant, such as Davis Colors Tint #569. A ratio in the range of 82% wt. cement, to 18% wt. cement colorant, can be used in Formula A to obtain a resultant product pathway surface, to match the natural color of decomposed granite. Obviously, colorant/cement ratio can be adjusted to accommodate the use of different aggregates.

In one embodiment, a predetermined formulated mixture of the cement and colorant can be placed in sacks and sold to the industry in the same manner as non-colored cement. Suitable sacks could be such as those used for selling 60 lb. and 80 lb. sacks of cement or concrete. Such sacks often contain one or more layers of paper, and/or one or more layers of plastic, although obviously, any suitable size of sack and material may well be used, which is suitable for containment, and transport of dry mixture. A mixture of cement and colorant can also be blended and delivered in bulk to a cement plant, or to a large jobsite for example, such as in a dump truck, or cement transport truck, where a user will add in the aggregate. These shipping methods minimize the volume and weight during shipping.

In another embodiment, the mixture of cement and colorant can be blended with aggregate, such as D.G. or other crushed rock, and this blend can be bagged in sacks and sold to the industry, where the user will not need to add the aggregate. With this type of embodiment the color is more consistent than if various types of aggregate were used by consumers or surfacing contractors. Obviously the mixture containing cement, colorant and aggregate can also be shipped in bulk from a mixing plant to a jobsite or cement plant. Such bulk delivery can be done with dump trucks or train cars for example.

A typical ratio of mixture for a dry tinted cement mixture such as described above as Formula A, containing Decomposed Granite aggregate, with a finished product color resembling the golden color of D.G., would include approximately 98.5% wt of D.G., 1.2% wt. Cement, and 0.3% wt. Davis Tint yellow #569.

In another embodiment of a dry tinted cement mixture created to produce a stronger harder yet pourous finished resultant solid product with a golden yellow color, a higher proportion of cement can be used to increase the hardness of the resultant solid product. Roughly double or triple the amount of cement can be used compared to the original formula 1, and such might be referred to by those in the industry as roughly a “two sack mix”. In such embodiment, named herein for example as Formula B, twice the amount of cement is used as in formula A. A recipe used to create Formula B could consist of the following weights per cubic yard of mixture;

| | | |
|---|---|---|
| 3615 | pounds | Felton D.G. #1 Gold crushed rock |
| 118 | pounds | Cement-Hanson, Type 1/2 |
| 65 | pounds | Water |
| 12 | pounds | Davis color #569 Yellow |

The relative % weight ratios for this example Formula B are roughly 95% crushed rock, 3% cement, 1.7% water, and 0.3% colorant. It should be noted that when this particular batch of mixture was made using these ratios to create Formula B, that the moisture content for the D.G. crushed rock prior to blending was recorded at 4.6% wt., and after blending, the moisture content of this batch was measured as 6.2% wt. Obviously, dry tinted cement mixture batches can also be made with variations of these formula ratios, as could be adjusted for a particular usage with a reasonable amount of experimentation by those skilled in the art. In general, a darker type of crushed rock aggregate would require more color tint to be added, and also, when more cement is used, more tint may also be desired.

Furthermore, in some embodiments, more than one type of colorant may be added to create a desired color for a dry tinted cement mixture. In one such example, which is especially useful when a dark colored crushed rock is used, and where a light colored end product is desired, then a white colorant cement tint can be used in conjunction with a second cement tinting color, such as yellow.

Such a combination of white colorant and yellow colorant is useful for example, when a golden colored end product is desired, and where a dark colored crushed shale rock is used for the crushed rock aggregate starting material. In a particular example embodiment of such a case, a mixture can be blended which shall be called Formula C for usage of such an example within this disclosure. Such a dry tinted cement mixture for Formula C can be made comprising; 62 pounds crushed shale aggregate, 1.125 pounds cement, 16 ounces of yellow cement tint, and between approximately 3-6 ounces of white cement tint. Slight mistings of water are added as needed, when the mixture is about to be final blended and applied.

In yet another useful embodiment variation, the resultant mixture can be made even stronger and more fracture resistant by adding fibers to the dry tinted cement mixture. A good selection of such fibers might be polypropylene microfilament fibers such as SI Concrete Systems's products called Stealth, Fibermesh, or Enduro.

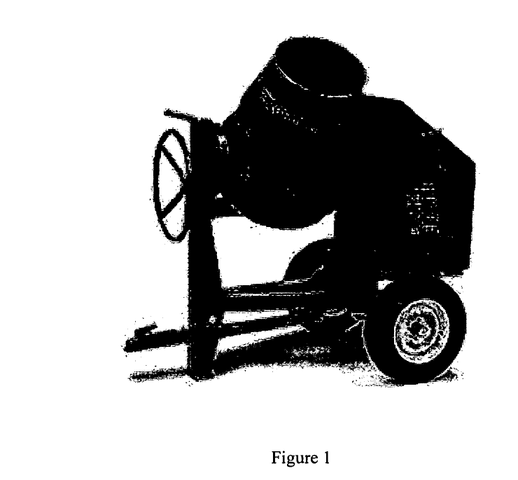

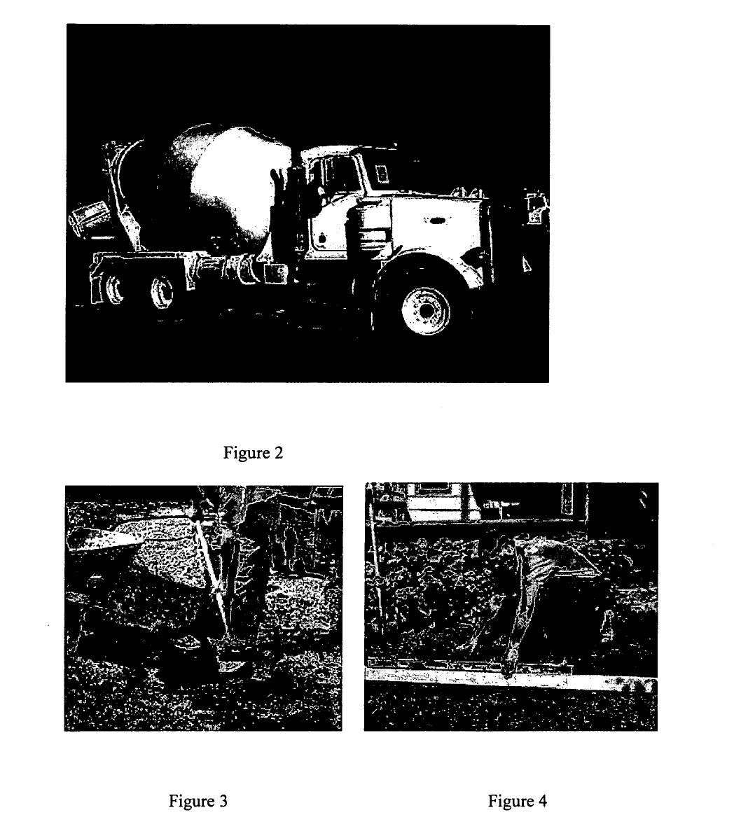

When the end user is ready to apply the dry tinted cement mixture to an area to be surfaced, the final ingredients are blended. Blending of the cement and colorant and aggregate can be done at a cement formulating plant, or packaging plant, or in a cement truck, or a portable cement mixer, or by hand in a tub or wheelbarrow for example, depending upon the amount of mixed material desired. Some preferred powered mixing vessels which are very useful in the blending steps of the method include a portable powered cement mixer, as shown in FIG. 1, and a cement mixing truck, as shown in FIG. 2, both of which are usable for blending the ingredients of a mixture prior to moistening, and also for mixing steps comprising slightly moistened mixtures. Blending of the cement, the colorant, and in some embodiments the aggregate as well, may also be performed at cement formulating plants and/or packaging plants for large scale volumes of production (not shown in figures). Thorough blending is important to achieve uniform color within a batch of mixture.

While the dry ingredients of a mixture formulation are being mixed, one or more light mistings of water are added, and the lightly moistened mixture is thoroughly blended. Once moisture is added, placement and compression must be done before the moistened mixture sets and hardens. A moistened dry tinted cement mixture will typically harden considerably after the a few hours.

One way to gauge the right amount of water is when the moistened blended mixture forms marble sized balls or clumps, which are easily broken up, similar in texture to moist earth clumps which hold lightly together and are easily crumbled. If the moistened blended mixture forms balls or clumps which are larger, such as up to the size of baseballs, the formula can still be used, but it is preferred that such larger sized balls of moistened mixture should be broken up as the material is spread into place, such as with a heavy iron rake.

At this point the mixture is ready for application to the area to be surfaced. If too much water is added, the mixture becomes very sticky, and will stick to the tools used, and to the rolling and tamping equipment, making a good finished application very difficult. The mixture is not typically wetted nearly as much as conventional concrete, which is typically used as a wet pourable slurry. Due to the nature of construction materials, rock aggregate is typically stored piled out-of-doors where it is exposed to the elements. Various amounts of moisture content may be inherent in a pile of aggregate depending upon the recent weather conditions and upon composition and degree of fracture of a crushed rock aggregate. Thus it is very difficult to prescribe an exact weight by volume of water mistings needed to be added to produce the slightly moistened condition preferred in practicing the present invention. Based upon the descriptions included herein, rather than prescribing an exact weight per volume of water, those skilled in the art will be able to make and use this invention with only a reasonable amount of minor adjustments and experimentation needed.

Many types and colors of tint may be used depending upon the natural color of the rock aggregate being used, and upon the desired finished color for the resultant product. Colorants which are usable in these formulations may include concrete colorants, and paint tints, amongst others which are known or may be used by those skilled in the arts. Metal oxides are very commonly the primary ingredient in some such colorants, such as yellow oxides for yellow tints, red oxides for reddish tints, and brown oxides for brown tints, amongst others.

Once a dry tinted cement mixture formulation is blended with aggregate and light mistings of water, the mixture is ready to use and can be placed into the desired area to be surfaced. The mixture is applied to the surface area, usually several inches thick, and then spread, packed, tamped, or mechanically pressed, such as with a roller type piece of equipment, which are common in the industry. Although most of the embodiments described in detail here for example, typify bulk areas for surfacing, such as walkways and patios, it is also possible to practice the formulations and methods described here to place a moistened batch of mixture into one or more preformed frames, where the finished hardened material can be removed and used, such as for as a paving block, for placement elsewhere besides where it was originally cast. Rows of such frames could be laid on a flat surface with a smooth under surface which facilitates removal of the finished product. Such forms can be filled with moistened mixture, and rolled or tamped for compression in similar manners described for surfacing of bulk areas.

Liquid colorants could also be added in other embodiments, but liquid tint would need to be added to the other dry ingredients only just prior to usage, or the cement will activate and set. Liquid tints would also add moisture to a dry mix, and the amount of fluid added would have to be carefully adjusted accordingly, or the mixture may become too wet and sticky for good usage.

Method of Using the Invention

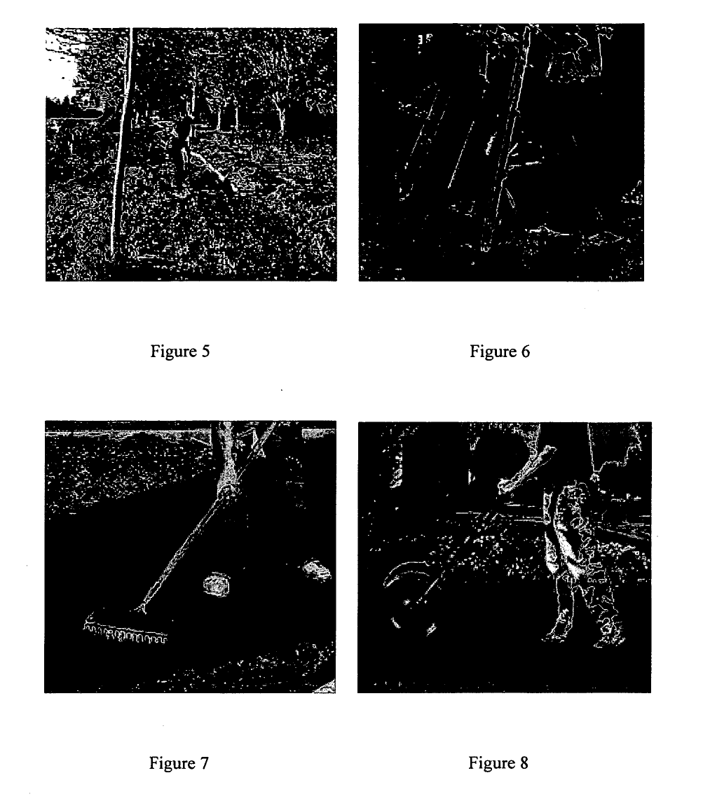

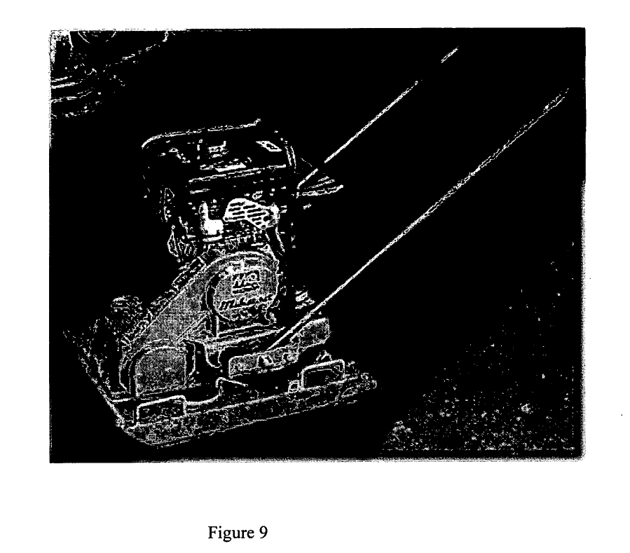

A preferred embodiment method of using the inventive formula for making a pathway surfaced with dry tinted cement mixture is illustrated in FIGS. 3, 4, 5, 6, 7 and 8, and shall now be described in detail. For making pathways of dry tinted cement mixture, an earthen sub-grade or sub-bed is often prepared, graded and compacted, prior to adding the dry tinted cement mixture for making the walkway surface. Once the area to be surfaced is excavated, graded and prepared, then dry tinted cement mixture is blended with aggregate, and a light misting of water. The slightly moistened mixture is then poured or shoveled onto the prepared sub-bed, and spread to fill the desired area. The moistened mixture is spread to a grade slightly higher than the desired finished grade, to allow for compaction. Once the mixture is spread to fill the desired area to a level slightly above finished grade, then the mixture is compressed, such as with rolling and/or tamping equipment. FIG. 9 shows a picture of a powered tamping machine called a Vibra-plate which is suitable for compression of small and moderate sized surface applications. The amount of compression desired is in the approximate range used in the industry for making asphalt roads. Depending upon the size of the surfaced area, compression can be done with hand tamping tools like pole handled tampers, or motorized vibra-plate type tamping equipment. Rolling can be done on smaller areas with common lawn rolling equipment, and on larger jobs a powered riding roller machine can be used, such as those known in the industry as a steam roller, although the modern versions of so called steam rollers are often gasoline or diesel powered machinery. Tamping or rolling compression is done until the material is compressed to the desired finished grade. The amount of compression desired is approximately the amount used when compressing hot asphalt, or other types of aggregated based surfacing materials.

As with other cement based mixtures, once initially moistened, the final placement and working must be completed before the cement chemically sets and hardens, usually within a few hours. Other similar method steps can be used to practice the present invention, as will be known or devised by those skilled in the arts, and other types of uses for surfacing can also be done.

To keep the mixture contained in the desired area, header boards can be placed along the edges of the area to be surfaced, as is done with conventional concrete, although simple earthen borders may also be used if desired. Also, a 2% sideslope can be used for the finished surface, to facilitate heavy rain runoff.

In another possible embodiment the mixture can be applied using automated or semi-automated machinery such as an asphalt laying machine, which applies the mixture, spreads it and compresses it. Other methods can obviously be used to place, spread and compress dry tinted cement mixtures. Similarly, depending upon size and scale of an area to be surfaced, various heavy construction equipment can be used

In addition to the basic embodiments disclosed above which describe examples of the inventive method, several additional preparation steps can be taken to produce a long lasting surfaced area. Compaction of the layers is important when preparing the area to be surfaced, and in applying the inventive mixture. In one embodiment, an earthen subgrade is excavated and thoroughly compacted. Next a sub-bed of drain rock is added to the sub-graded area and compacted. A good choice for the drain rock layer would be a 4″ deep layer of ¾″ granite chunks. In a preferred embodiment, once the sub-bed is laid and compacted, a first layer of the moistened dry tinted cement mixture is added to the prepared area to be surfaced, and spread to fill the desired space, typically in the range of a first layer 4″ deep. Next the first layer of mixture is spread into the area, and then lightly compacted. Next, one or more additional layers of mixture can be added on top of the first layer, and spread and compressed to approximately 2″ deep of moistened dry tinted cement mixture. Once all of the desired layers of mixture are in place, the area is thoroughly compacted. One or more light mistings of water can be applied between layers, and/or after final compression to help the material set, which is especially useful in hot dry weather.

Surface texturing of the top of the final layer can be done with additional mistings of water and working the surface with tools such as trowels, floats, stamps and brooms depending upon the desired final texture.

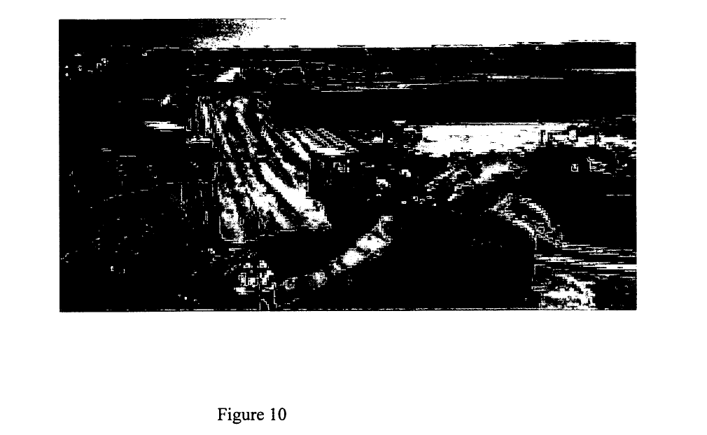

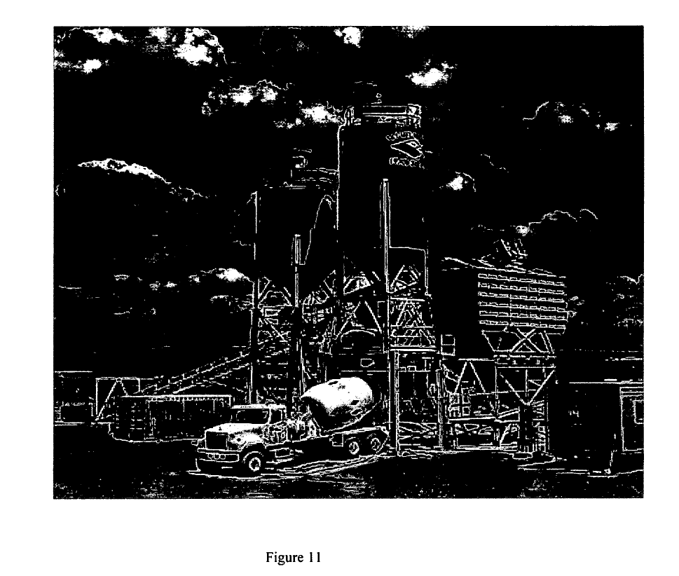

Large scale area surfacing projects can be done with equipment scaled to an appropriate size. For example, FIG. 10 shows a picture of large scale grading earth moving equipment suitable for grading and sub-bed preparation on large areas to be surfaced, such as parking lots and large roadways.

FIG. 11 shows a picture of a cement mixing plant loading a cement mixing truck. Such Equipment is suitable in large scale area surfacing projects, for blending two or more of the formula ingredients of dry tinted cement mixture. Portable as well as non portable cement mixing plants would be suitable for blending formula ingredients. Standard cement mixer trucks can be useful for transporting and blending of dry mixtures or slightly moistened dry mixtures.

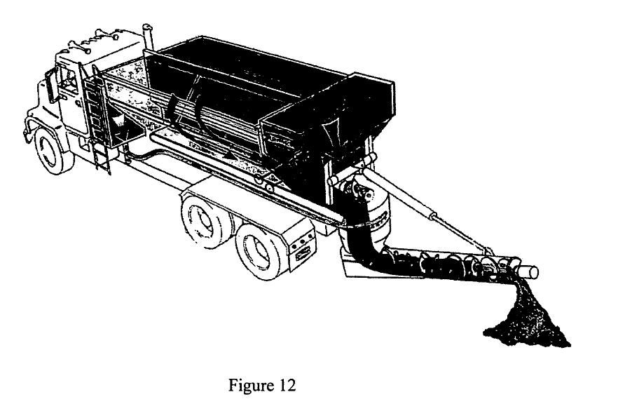

FIG. 12 shows a picture of a mobile cement mixer truck suitable for blending and placement of mixtures for moderate sized areas to be surfaced. With this type of equipment, mixture formulation ingredients can be loaded into separate compartments in the truck mounted unit. The ingredients are metered and blended in a mixing component, and discharged by an auger from the mixer onto the area to be surfaced. Small and moderate sized mixture batches can be made fresh as needed with this type of equipment.

I claim:

1. A dry mixture comprising cement and colorant.

2. A mixture as in claim 1 where the colorant comprises yellow oxide material.

3. A mixture as in claim 1 where the ratio of cement to colorant is on the order of 82% wt. cement and 18% wt. colorant.

4. A mixture as in claim 1 where the mixture is packaged in a sack comprising at least one layer of paper.

5. A mixture as in claim 1 where the mixture is packaged in a sack comprising at least one layer of plastic.

6. A dry mixture comprising cement and colorant and rock aggregate.

7. A mixture as in claim 6 where the colorant comprises yellow oxide material.

8. A mixture as in claim 6 where the ratios of the mixed ingredients are on the order of 98.5% wt of aggregate, 1.2% wt. Cement, and 0.3% wt. colorant.

9. A mixture as in claim 6 where the mixture is packaged in a sack comprising at least one layer of paper.

10. A mixture as in claim 6 where the mixture is packaged in a sack comprising at least one layer of plastic.

11. A method of preparing a formulation comprising:
Blending together a mixture comprising the ingredients;
Cement, and
Colorant,
in a mixing vessel.

12. A method as in claim 11 where the ingredients of the mixture formulation further comprises Aggregate.

13. A method as in claim 12 where the ingredients of the mixture formulation are blended while dry.

13. A method as in claim 12 where the ingredients of the mixture formulation are blended, and are slightly moistened with a nominal amount of water.

14. A method as in claim 13 where the blended mixture is used to surface an area, where the method comprises the steps of:
Blending the slightly moistened mixture, and
Pouring the blended moistened mixture onto an area to be surfaced, and
Spreading and leveling a first layer of the mixture onto the area to be surfaced to form a grade and slope.

15. A method as in claim 14 where the method further comprises at least one step of compressing the mixture.

16. A method as in claim 15 where the method further comprises the step of spraying additional moisture onto the mixture after a compression step.

17. A method as in claim 14 where the method further comprises the addition of one or more additional layers of slightly moistened mixture upon the first layer, and then followed by a compression step.

18. A method as in claim 15 where the area to be surfaced is within a temporary boundary form, and the finished hardened mixture is then removed from the form.
